(19) United States
(12) Patent Application Publication
(10) Pub. No.: US 2006/0112162 A1
(43) Pub. Date: May 25, 2006

(54) Method, terminal and server for selecting a server address

(76) Inventors: Emmanuel Marot, Paris (FR); Gilles Anquetil, Montrouge (FR); Bruno Botvinik, Sainte Genevieve des (FR)

Correspondence Address: RATNERPRESTIA, P O BOX 980, VALLEY FORGE, PA, 19482-0980, US

(21) Appl. No.: 10/520,609

(22) PCT Filed: Jun. 16, 2003
(86) PCT No.: PCT/FR03/01816

§ 371 Date: Aug. 31, 2005

(30) Foreign Application Priority Data
Jul. 8, 2002 (FR) 02/08573

(51) Int. Cl. G06F 15/16

(52) U.S. Cl. 709/203

(57) ABSTRACT

The invention concerns a method for communication between a terminal and a server of a communication network, a server or data of the server being identified by an address. According to the invention, when the user of the terminal executes an input, codes stored in a base of the terminal and selected on the basis of first parameters are displayed so that the user may select a code, then the selected code is transmitted to a routing server which identifies, on the basis of second parameters, an address associated with the selected code stored in a base of the terminal, and the identified address is transmitted to the terminal which automatically accesses the identified address.

The present invention pertains to a method, a terminal and a telecommunications server.

A telecommunications network enables a user provided with a terminal, connected to this network, to access data stored in a server of the network.

To that end, the terminal transmits a request, via the network, to this server, which then, in response, communicates data to the terminal. These transmitted data may correspond to the data requested—it is thus said that the terminal accesses the data or the address of these data—or to data not identified in the request, such as data presenting the services offered by the server. In the latter case, it is said that the terminal accesses the server or the address of the server.

To permit access to a server, a request must indicate an identifier, or address, of the latter, so that the network transmits this request to this server.

Analogously, to access data, the request must indicate the address of the server storing these data and a file name appropriate for these data. It is then considered that, to identify these data, the terminal transmits a data address indicating the file and the server considered. Furthermore, when a terminal receives data from a server, it is said that the terminal accesses the site of this server related to these data.

When a terminal transmits a server address, the latter must be coded in accordance with the communication protocol used by the network. For example, when a terminal wishes to access a server of the internet network, the address of the requested server must be specified according to the Hypertext Transfer Protocol (HTTP) suitable for the internet network. Such an address appears in a form such as: http://www.siteweb.com.

According to another example, if the terminal is a portable telephone connected to a mobile telephone network, such as the WAP (Wireless Access Protocol) network, a server address may appear as: http://wap.siteweb.com.

It appears that the addresses of servers according to a communications protocol are complex, long and similar to each other. Therefore, when these addresses are input by the user of a terminal to send a request, input errors may occur, especially if this input is executed by means of a compact keypad associating several elements with a same key, such as the keypad of a portable telephone described below.

When data addresses are considered according to a communications protocol, they have the same drawbacks as the server addresses, i.e., they are generally complex, long and similar to each other.

Thus, when considering that the WAP server defined by the address http://wap.siteweb.com comprises data related to the meteorological situation in France, this data address may have a form, such as http://wap.siteweb.com/meteo/index.asp?region=france.

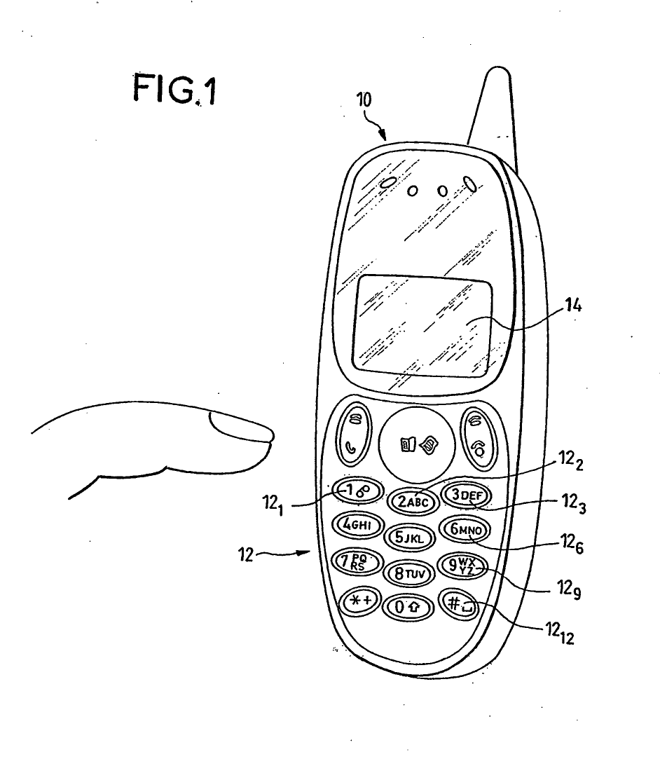

Consequently, data address input errors may occur analogously to server address input errors and especially when the latter are input by means of a compact keypad, such as the keypad of a portable telephone, as described below on the basis of FIG. 1.

FIG. 1 shows a mobile telephone 10 comprising a keypad 12 with dimensions limited by the reduced size of the telephone 10. In fact, the keys 12₁, 12₂, . . . 12₁₂ that make it possible to input the elements, such as signs, numbers or letters, of an address are particularly close to one another and have small dimensions, which causes input errors when the user unintentionally presses a key.

Moreover, since the terminal 10 is equipped with a compact keypad, only one key of this keypad permits the inputting of various letters, symbols and numbers. Thus, the number 9 and the letters w, x, y and z are associated with a same key 12₉, and each of these elements can be input on the basis of the number of times this key 12₉ is pressed consecutively and within a certain time. For example, the letter w is input by pressing the key 12₉ twice consecutively, while pressing this key 12₉ three times consecutively inputs the letter x.

Consequently, input errors are caused by these constraints of repetition and time during the input of an element. For example, the letter x is input instead of the letter w when the user of the terminal accidentally presses the key 12₉ once more.

In addition, when input errors occur, the latter are difficult to detect in spite of the display of the input elements on the screen 14 of the terminal because of the small display dimensions of the input elements on this screen 14.

Furthermore, after an input error, the terminal sends a request to a nonexistent or erroneous address. For example, taking the input error indicated above into consideration, the address http://xap.siteweb.com is input instead of the address http://wap.siteweb.com. In these cases, the communication between the terminal and the server desired by the user cannot be established.

In case of an error in the input of a server or data address, the user of a terminal must detect and correct this error manually. In other words, the erroneous address cannot be automatically corrected by the terminal.

Moreover, when a user does not succeed in accessing a server or data after an input error, he frequently attributes this failure to a connection problem, such as an overload of the network, and abandons any attempt to connect to the server.

It is also possible for a user to access a server or data through search servers (or engines) designed to indicate the server or data addresses corresponding to key words.

However, such searches generate many, more or less pertinent, results, the display of which requires many display pages or screens, and especially when the screen used is a screen with small dimensions such as a screen 14 of a portable telephone 10.

Therefore, the reading of these data is tedious and requires generally too much time for the user of the terminal who abandons his search.

According to another method, the address of a server or data is determined by proceeding by means of a tree structure indicating the nature and/or the function of the server sought.

This method has the drawback of requiring a generally long and large tree structure, whose display is unsatisfactory on screens of reduced size, such as portable telephone screens.

Finally, according to a last method, the user of the terminal may store server addresses in a specific memory of the terminal, such as an agenda or a list called favorites.

Such a method has the drawbacks of only being able to be used for addresses which the user has already accessed, and stored, and of being limited by the storage capacity of the terminal.

It should be pointed out that the methods described above for accessing a server or data have the drawback of not enabling a user of a terminal to use a common interface for accessing different servers or different data. In other words, the user must adapt to the operating and/or display specificities of the different types of access, for example, different interfaces of search servers, which tends to make the access to a server or data a long, and therefore expensive, operation, and less effective than if the user executed the majority of his accesses with a single interface.

The present invention eliminates at least one of the drawbacks mentioned above. It pertains to a method for communication between a terminal and a server of a communication network, with a server or data of a server being identified by an address, which is characterized in that, when the user of the terminal executes an input, codes stored in a base of the terminal and selected on the basis of first parameters are displayed so that the user may select a code, then the selected code is transmitted to a routing server which identifies, on the basis of second parameters, an address associated with the code selected and stored in a base of the server, and the identified address is transmitted to the terminal which automatically accesses the identified address.

The use of such a method, which is executed during a communication, has many advantages. Thus, the complete input of the long and complex address of a server or data as described above is not necessary to access this server or these data.

In fact, the user may select a displayed code once he executes a short input, this displayed code being, for example, descriptive of a service sought. The selected code is then automatically transmitted to a routing server which identifies an address associated with this code and transmits it to the terminal which then automatically accesses the server or data corresponding to this address.

For example, it can be considered that a code “météo” corresponds, in the base of a routing server, to the address http://www.meteorologie.com of a server providing a meteorological service, and that, furthermore, a code “météo” is stored in the code base of the terminal. Consequently, the simple input of the first letters “mét” of the code “météo” may lead to a display of the code “météo,” when, according to an embodiment of the present invention, the first selection parameters comprise the similarity between the elements input and the elements of the stored codes.

If the displayed code “météo” is selected by the user of the terminal, the terminal transmits this code “météo” to the routing server which, identifying the address http://www.meteorologie.com as the address associated with this code, transmits this address http://www.meteorologie.com to the terminal so that the latter accesses this meteorology service.

Thus, the user accesses a server by inputting three letters “m,” “e” and “t,” and then selecting a suggested code, which corresponds to a number of operations less than the input of the address http://www.meteorologie.com of the server.

Analogously, the method is applicable to the access of data. Thus, it can be considered that the code “météoFr” corresponds, in the base of the routing server, to the meteorological data address http://www.meteorologie.com/index.asp?region=france appropriate for France, a code “météoFr” being stored in the code base of the terminal. Consequently, the simple input of “met” leads to the display of the code “météo” and of the code “météoFr” which can be selected by the user.

If he makes this selection, the terminal transmits the code “météoFr” to the routing server, and the routing server in turn communicates the address associated with this code, i.e.: http://www.meteorologie.com/index.asp?region=france.

It should be pointed out that the codes displayed, which are stored in the terminal, may have been transmitted by the server from the input.

In one embodiment, a command is transmitted from the routing server changing the code base of the terminal and/or changing an address of the routing server stored by the terminal for transmitting a code to the routing server.

In this case, according to one embodiment, the changing of the code base of the terminal includes at least one of the following operations: The storage of a new code, elimination of a code, creation, changing or deletion of a code group or dictionary, allocation of a display priority among codes, for example, depending on the dictionary from which this code is derived.

This embodiment makes it possible to update the codes stored in the terminal depending, for example, on their interest. Thus, if a film project entitled Film is being offered, a code “Film” can be transmitted by the routing server so that it is stored in the terminal, this code being associated with a data or server address related to this project in the address base of the routing server, directing the terminals to these data or this server when the code “Film” is transmitted by a terminal.

Consequently, if this film project is abandoned, this same code “Film” can be deleted from the code bases of the terminals and from the address base of the routing server in order to free up storage resources.

According to a second example, if the terminal accesses the meteorological server described above, the routing server can transmit a code dictionary appropriate for this server, comprising, for example, the codes “United States” and “France” relative to meteorological data appropriate for one of these countries. Consequently, if the user inputs “Fra,” the code “France” is displayed, so that the user may select it and access the data associated with this code “France,” which are identical to the data associated with the code “météoFr.”

Thus, the present invention makes it possible to access identical data by different codes.

The codes used by the present invention are not restricted by a communication protocol. In fact, they may be arbitrarily defined by users of the method, such as a telecommunications operator or access provider.

Therefore, a method according to the present invention tends to limit input errors since the codes can be selected to be relatively short, simple, distinct from one another and descriptive of a service.

Moreover, it should be pointed out that, due to a method according to the present invention, a terminal has a particularly user-friendly interface. Thus, by displaying codes similar to the input executed by the user, he can access the requested server in spite of an input error. For example, if the user inputs “mdt” instead of “met,” the code “météo” similar to the input shall be displayed for taking into account a possible input error.

In addition, this same interface can be used for accessing different servers or different data. In other words, the user can use a simple and familiar interface for a variety of accesses.

By selecting a code that is suggested by the terminal, the user is thus ensured that his request corresponds to an accessible service, i.e., that the communication that is executed by his terminal corresponds to a server or data available on the network.

Finally, a code that is used in a method according to the present invention requires a storage capacity that is less than a server address, such that, by storing codes, the terminal has more storage than by storing complete addresses of servers or data in an agenda or in a favorites file.

Consequently, with a constant storage size, a user generally has more codes available in the memory of his terminal than server or data addresses.

In one embodiment, the change command is transmitted when the server communicates an address to the terminal.

According to one embodiment, the similarity between input and a stored code is considered to be a first parameter, such that the codes displayed are the codes most similar to the input.

In this case, the similarity between the input and a code can be determined by allocating a cost for each correction of an element of the input, making it possible to obtain an element of the code, for example, by substituting or deleting an element of the input or by inserting an element into the input, since the lower the sum of the costs for obtaining a code by correcting an input, the higher is thus the similarity between an input and a code.

In one embodiment, codes are selected and are displayed as the input, considering the first elements input with the first elements of the codes of the base.

According to one embodiment, the input is considered to be a code that is transmitted to the routing server.

In one embodiment, the codes of the terminal are grouped into dictionaries, each dictionary being characteristic of a category of codes, such as codes related to accesses made by the terminal or to a list of the user, a service provider, a telecommunications operator, a network access provider or an operator of the routing server.

In one embodiment, the context of the input is considered to be a first selection parameter, setting a selection priority among the codes coming from different dictionaries, this context being related to at least one of the following parameters: Data displayed by the terminal, an access in progress, a communication in progress, a geographic location of the terminal, a telephone operator transmitting the communications, a network access provider, a history of the accesses made, sites indicated as favorites, the type of the terminal, an operating language of the terminal.

Thus, when a terminal is in the process of accessing a server providing information about a film, for example, this server may request information characteristic of the locations or the films by means of distinct input fields displayed on the screen of the terminal. Consequently, depending on the input field used to transmit the information, the context differs and codes related to the locations or related to the films shall be selected on a priority basis.

In one embodiment, at least one parameter of the context of the input is transmitted to the routing server during the transmission of a code.

According to one embodiment, since addresses or codes associated with codes are grouped by dictionaries characteristic of an address category, a parameter of the context of the input and/or an identifier of the user is used as a second selection parameter allocating a priority to an address coming from a first dictionary vis-à-vis an address coming from a second dictionary or to a code coming from a first dictionary vis-à-vis a code coming from a second dictionary.

In one embodiment, intermediate servers comprising an address base coming from the base of the routing server are used to receive the code sent by the terminal for transmitting an address or codes to this terminal, for transmitting the code received to the routing server or for transmitting commands changing the code base of the terminal.

The present invention also pertains to a communication terminal accessing servers or data of these servers via a communication network by means of an address according to a communication protocol. According to the present invention, the terminal is characterized in that it comprises means for displaying codes stored in a base and selected on the basis of first parameters, when the user of the terminal executes an input, so that this user may select a code, means for transmitting the selected code to a routing server, and means for receiving an address from this routing server and automatically accessing this address, or receiving codes and displaying them.

According to one embodiment, the terminal comprises means for receiving from the routing server a command changing its code base and/or changing an address of the routing server.

In one embodiment, the terminal comprises means for changing its code base by executing at least one of the following operations: The storage of a new code, elimination of a code, creation, changing or deletion of a code group or dictionary, allocation of a display priority among the codes, for example, depending on the dictionary from which this code is derived.

According to one embodiment, the terminal comprises means for considering the similarity between the input and a stored code to be a first parameter for selecting displayed codes.

In one embodiment, the terminal comprises means for determining the similarity between the input and a code by allocating a cost for each correction of an element of the input, making it possible to obtain an element of the code, for example, by substituting or deleting an element of the input or by inserting an element into the input, since the lower the sum of the costs for obtaining a code by correcting an input, the higher is thus the similarity between an input and a code.

In one embodiment, the terminal comprises means for dividing the code base into sub-bases, or dictionaries characteristic of a code category, such as codes related to the accesses made by the terminal or to a list of the user, a service provider, a telecommunications operator, a network access provider or an operator of the routing server.

According to one embodiment, the terminal comprises means for considering the context of the input to be a first selection parameter, setting a selection priority among the codes of different dictionaries, this context being related to at least one of the following parameters: Data displayed by the terminal, an access in progress, a communication in progress, a geographic location of the terminal, a telephone operator transmitting communications, a network access provider, a history of the sites visited, sites indicated as favorites, a manufacturer of the terminal, an input language.

In one embodiment, the terminal comprises means for selecting and displaying codes as the input on the basis of the similarity between the first elements input and the first elements of codes of the base.

The present invention also pertains to a communication network server such that a server or data of this server are accessible by means of an address according to a communication protocol, this server being characterized in that it comprises means for identifying, in a base, an address or codes associated with the code received on the basis of second parameters and for transmitting this address or these codes to the terminal, and means for commanding a change in a code base in the terminal transmitting the code.

In one embodiment, the server comprises means for considering the similarity between a code transmitted by the terminal and codes associated with addresses in its base to be a second selection parameter.

According to one embodiment, the server comprises means for dividing the code base into sub-bases, or dictionaries, comprising codes which are characteristic of a service provider, a telecommunications operator, a network access provider or an operator of the routing server.

In one embodiment, the server comprises means for considering the context of the transmission of the code by the terminal to be a second selection parameter, setting a selection priority among different code or address groups or dictionaries, this context being related to at least one of the following parameters: An input field placed in the access means of the terminal, data displayed by the terminal, an access in progress, a communication in progress, a geographic location of the terminal, a telephone operator transmitting communications, a network access provider, a history of the sites visited, sites indicated as favorites, a manufacturer of the terminal, an input language.

In one embodiment, the server comprises means so that, when it transmits a server and/or data address to the terminal, it commands the terminal to store codes, or a code dictionary, on the basis of the address of the server or data transmitted.

Other characteristics and advantages of the present invention shall become apparent from the nonlimiting description of some of its embodiments provided below with reference to the attached drawings, in which:

FIG. 1, already described, shows a portable telephone provided with a compact keypad,

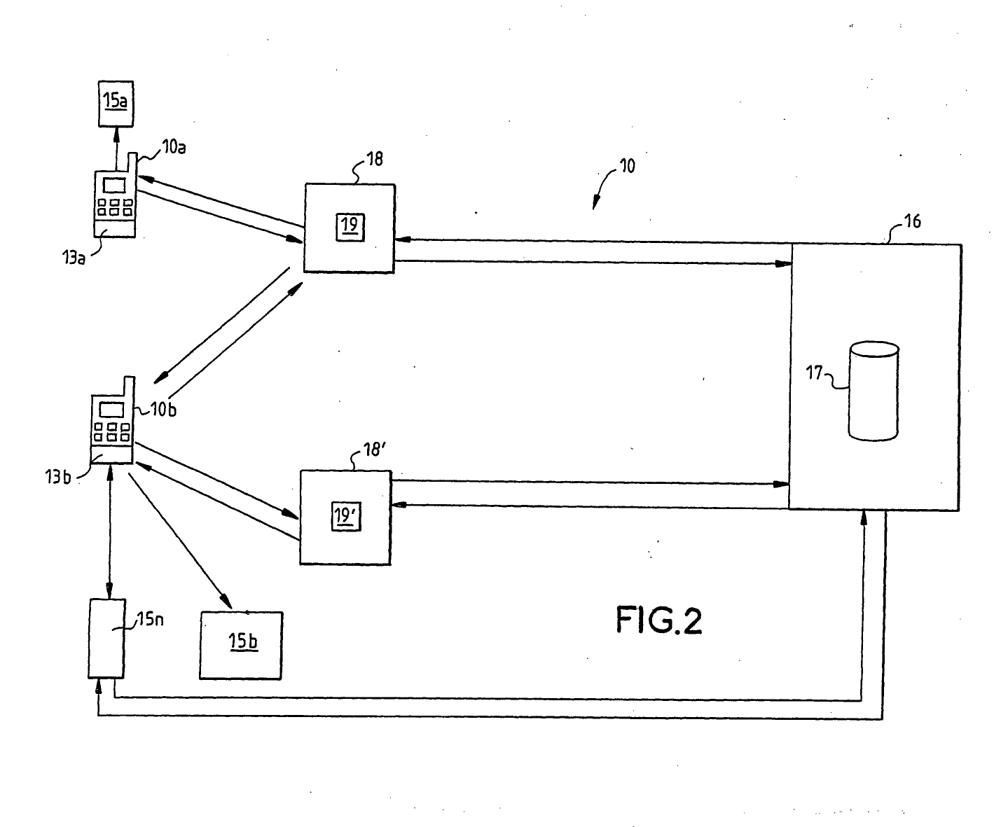

FIG. 2 is a diagram of a network comprising terminals and servers according to the present invention,

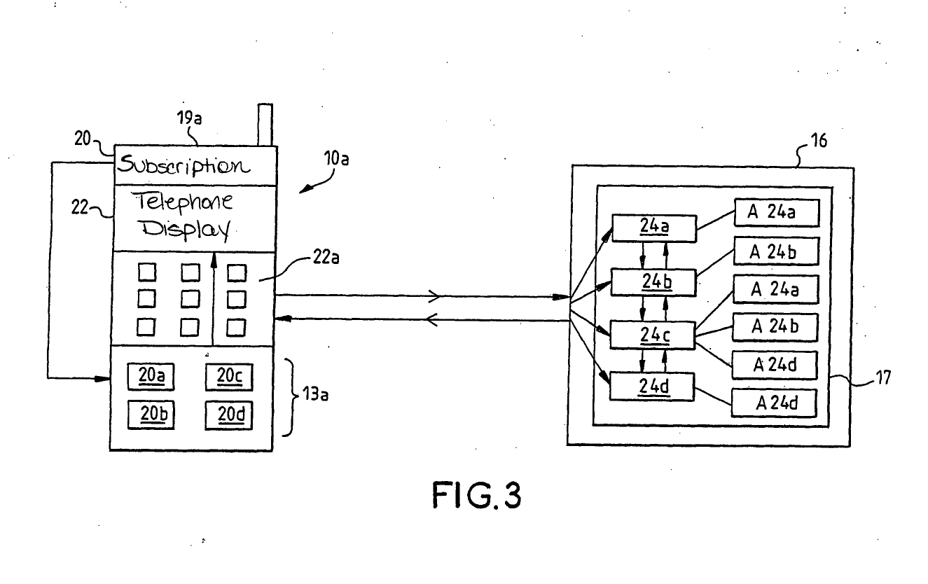

FIG. 3 is a diagram showing the use of the first and second selection parameters, and

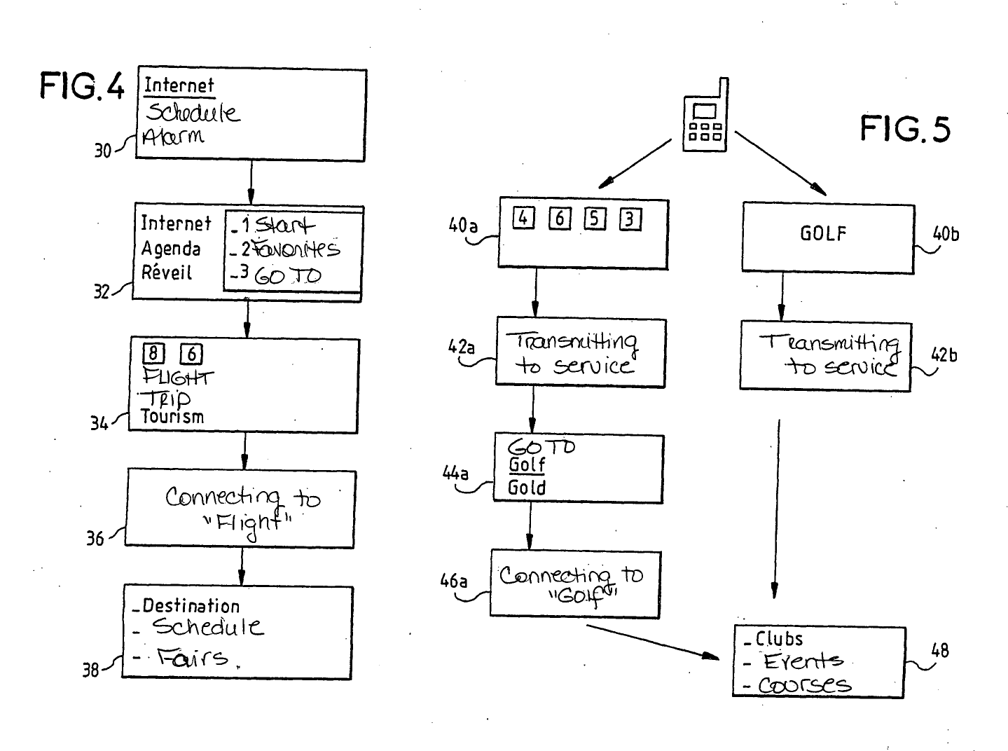

FIGS. 4, 5 and 6 show applications of a method according to the present invention.

FIG. 2 shows a telecommunications network 10, comprising a terminal 10a and a server 15a, which the user of the terminal 10a wishes to access according to a method according to the present invention.

To that end, the terminal 10a comprises means 13a so that its user executes an input and means so that codes, selected according to the first parameters described below, are displayed on the screen of the terminal in such a way that the user of the terminal may select one of the displayed codes.

These input and display means can be requested by the user of the terminal by different operations such as the pressing of a key or of a sequence of specific keys, the selection of an application in a menu of the terminal, the activation of a beacon inducing the terminal to access a given address or an automatic triggering after accessing a predetermined address.

To access an address of the network, the terminal comprises access means, which are called a navigator, which make it possible to transmit and to receive data via the network. Subsequently, when the navigator receives data from a server, it is said that the navigator accesses the site related to these data.

Moreover, the navigator can receive or transmit data to the means 13a so that, for example, the latter change the code base according to a command transmitted by the server 16 described below or trigger the display of codes transmitted by the server 16.

Conversely, the input means 13a may transmit a code and the address of a routing server 16 to the navigator so that, at first, the terminal transmits a code to the routing server 16, and that, subsequently, the latter transmits an address to the navigator in such a way that the terminal 10a accesses this address.

To that end, when one of the codes displayed is selected by the user and when the terminal 10a transmits this code to the routing server 16, the latter uses a data base 17 associating the codes with addresses, according to the communication protocol of the network 10, or with other codes as described below.

After having identified the address of a server 15a as the address associated with the code received by means of second parameters described below, the routing server 16 transmits this address to the terminal 10a in such a way that the latter automatically accesses the server 15a.

As shown in FIG. 2, the communications between the terminal 10a and the server 16 can be relayed by an intermediate routing server 18.

The use of the intermediate server 18 makes it possible to execute a first analysis of the code transmitted by the terminal 10a vis-à-vis a base 19 of data derived from the base 17 and corresponding, for example, to the most commonly requested addresses.

Thus, if a server or data address is identified by the intermediate server 18 by means of its base 19, it transmits this address to the terminal 10a without contacting the server 16. In fact, the use of intermediate servers 18 makes it possible to limit the work load of the routing server 16.

In one embodiment, the base 19′ of another intermediate server 18′ is distinct from the base 19 of the server 18, each of these bases comprising, for example, codes characteristic of distinct telephone operators.

Furthermore, a possible failure of one of its servers is thus overcome by using a second intermediate server. For example, considering a terminal 10b connected to an intermediate server 18′, a possible failure of this server 18′ can be detected by the terminal 10b in such a way that the latter transmits its request to the server 18.

In relation to the terminal 10b, a variant of the present invention is shown, such that the user does not select a displayed code, so that the input executed is considered to be the code which must be transmitted to the routing server 16.

In that case, it is possible that the server 16 identifies an address associated with this code, in which case the terminal is directed to this address, or that the server 16 cannot identify only one address associated with this code.

In the latter case, according to one embodiment, the routing server 16 transmits a search server address 15ᵣ to the terminal 10b, such that, when the terminal automatically transmits the code in question to this search server 15ᵣ, the latter automatically executes a search for server or data addresses corresponding to this input and then transmits the results of the search to the terminal 10b which displays these results so that the user may access one of the addresses displayed.

The terminal 10b consequently comprises means for storing the address selected by the user and for transmitting this address and the code sought to the server 16 which may update its base 17 by associating the code requested with the address selected by the user of the terminal 10b.

According to another embodiment, the server 16 comprises means so that, when it receives a code from the terminal 10b for which it cannot identify an associated address, it transmits this code to the search server 15ᵣ, which, in response, transmits to it the responses of the search executed in relation to this code.

These responses may then be transmitted to the terminal 10b in the form of codes generated from the results of the search, the addresses associated with these codes being stored in the base 17. Subsequently, the user of the terminal selects one of these codes, which is transmitted to the server 16 so that the latter transmits the address associated with the selected code to the terminal 10a.

In one variant, the responses of the search are transmitted to the terminal 10a so that its user selects one of these responses, the terminal accessing the address associated with this response, at first, and subsequently communicating to the server the address accessed and the code associated with the server 16 in order to update the latter.

It should be pointed out that a terminal transmits an identifier, during a transmission to the routing server 16, for example, to check the access of the terminal to the paid services. Moreover, the terminal transmits at least one parameter, described below, enabling the server 16 to identify an address associated with the code transmitted.

Codes stored in the base 17 of the server 16, associating addresses with these codes, must be stored in the code base of the terminals 10a and 10b.

For this, at first, this code base is loaded with codes stored by the routing server 16 during the first use of the method by the terminal. According to one variant, this code base is stored in the terminal prior to its sale.

Subsequently, when a terminal is provided with a first code base, the latter is changed by the server 16 in the course of a communication between the routing server 16 and this terminal, for example, after a request from the latter, so as to execute updates of the code base without executing specific communications.

The changes to the code base of a terminal may be commanded to the routing server 16 for updating codes or during the activation of a navigation beacon, triggering the access of the terminal to an address, as described below, assuming that the server 15a is a server related to film services.

In this example, the server 15a can transmit a navigation beacon to the terminal 10a, so that the latter establishes a communication with the routing server 16 so as to receive codes appropriate to the service provider A commanding the server 15a, such as “times,” “films” or “animations.”

In fact, each of these codes “times,” “films” or “animations” is associated with specific data of the server 15a, the addresses of these data being stored in the base 17 of the server 16.

Consequently, when the user of the terminal 10a executes an input to know the services proposed by the operator of the server 15a, codes characteristic of the provider A are available in the code base of the terminal 10a and are displayed on the basis of, among other parameters, the input and the similarity between the input and each code stored.

The similarity between the input and a code is determined by calculating a cost for each correction of an element of the input, making it possible to obtain an element of the code, for example, by substituting or deleting an element of the input or by inserting an element into the input, since the lower the sum of the costs for matching a code to the input, the higher is thus the similarity between an input and a code.

Furthermore, in this embodiment, the cost of a correction is weighted on the basis of the elements common to a key of the terminal and/or on the basis of the distance separating the keys of the terminal in relation to the element input and to the corresponding element of the code.

The address base 17 of the server 16 can be used by different users, such as telephone operators, while permitting these users to use codes appropriate for their services.

In other words, the server 16 makes it possible to provide a base of common addresses to different operators, the access to this base being personalized on the basis of codes appropriate for each operator, access provider or content provider.

Such a configuration has the advantage of making it possible for these operators to have common addresses, comprising all of the server or data addresses used by the operators.

Conversely, in an embodiment of the present invention, two distinct operators A and B have their own address base in the server 16. This embodiment has the advantage of making it possible for the operators of the routing server to have their own bases using codes and/or addresses specific to each operator.

It appears that a code transmitted by the terminal may be associated with different addresses in the base 17. Consequently, provisions are made for the server 16 to communicate to the terminal different codes associated with the code transmitted and related to these addresses, and the user then selects one of these codes, which, transmitted to the routing server, enable the latter to communicate an address to the terminal.

However, in order to limit the number of addresses identified, the base 17 is made up of sub-bases so that, by means of second parameters transmitted to the terminal, the number of sub-bases used to determine the address or addresses associated with a code is limited, consequently reducing the number of addresses that can be identified.

Analogously, the code base of the terminal 10a or 10b is made up of groups or dictionaries of codes such that, on the basis of first parameters, a limited number of dictionaries is used to select the codes that must be displayed.

Moreover, these parameters can be used to determine an order for displaying codes selected during an input or transmitted by the server, as described below based on FIG. 3, which shows the operation of these selection parameters by the routing server 16 and by the terminal 10a of FIG. 2.

Sub-bases 24ₐ, 24_{b}, 24_{c} and 24_{d} of the base 17 are shown in the server 16, the sub-base 24ₐ being related to addresses appropriate for an operator A, the sub-base 24_{b} being related to addresses appropriate for an operator B, the sub-base 24_{c} being related to a language and the sub-base 24_{d} being related to the film services server 15a.

The operator A associates a data address A₂₄ₐ, showing a subscription offer appropriate for this operator, with the code “Subscription,” transmitted by the terminal 10a. Analogously, the communication operator B associates a data address A_{24b} showing a subscription offer appropriate for this operator B with the code “Subscription.”

The sub-base 24_{c}, appropriate for the use of a given language, identifies three addresses A₂₄ₐ, A_{24b} and A_{24d}, the latter being related to a subscription to film services of the server 15a and also being identified in the sub-base 24_{d}.

During the transmission of the code “Subscription,” the terminal also transmits data related to the identity of the user and to the context of the input, such as, for example, the nature of the telephone operator and/or of the network access provider, the location of the terminal, a usage language, the type of the terminal, an access in progress of the terminal.

These data are then used as second selection parameters to determine the address A₂₄ₐ, A_{24b} or A_{24d} that must be selected and transmitted to the terminal. Thus, if the operator A transmits the code “Subscription” sent by the terminal 10a, the sub-base 24_{b} is not requested and only the addresses A₂₄ₐ and A_{24d} are selected by the server 16.

The server 16 may then consider that an access in progress is an exclusive parameter, such that only the dictionary 24d is used, the address A_{24d}, corresponding to an access in progress of the server 15a, being transmitted to the terminal 10a.

Conversely, if the nature of the operator transmitting the communications is an exclusive parameter, only the dictionary 24a is used and the address A₂₄ₐ is transmitted to the terminal 10a.

In other words, in each of the two latter cases, only one address sub-base is considered on the basis of second parameter(s).

In another case, an access in progress is a priority, but nonexclusive parameter, such that the nature of the operator transmitting the communications is also considered and that the two dictionaries 24a and 24d are used by the server 16.

Moreover, it should be pointed out that the server 16 comprises means for associating a code of its base 17 with one (or more) code(s), for example, according to glossary or subject criteria. For example, the codes “Telephone” and “Movies,” respectively, associated with the addresses A₂₄ₐ and A_{24d}, can be associated with the code “Subscription.”

If the server 16 identifies different codes associated with a code received, the server 16 establishes a priority among these associated codes in such a way that a limited number of codes is transmitted by the server 16 to the terminal 10a and so that these codes are displayed according to the priority indicated.

For this, one or more of the second parameters that are mentioned above are considered. For example, if the terminal 10a is in the process of accessing the server 15a and one access in progress is a priority parameter, the code “Movies” is displayed as a priority over the code “Telephone” in the display zone 22 of the terminal 10a.

Analogously to the selection of an address or codes in the base 17 associated with a code transmitted by the terminal, first selection parameters make it possible to determine which codes must be selected and displayed to the user in the display zone 22 of the terminal 10a when the user executes an input by means of the keypad 22a of his terminal.

It should be pointed out that, in one embodiment of the present invention, the first code that is displayed in the zone 22 of the terminal 10a is preselected to be the code that must be transmitted, thus reducing the number of key presses that the user of the terminal must execute to select a displayed code.

To this end, code sub-bases, or dictionaries, 20ₐ, 20_{b}, 20_{c} and 20_{d} are stored in the terminal 10a, a code dictionary comprising codes related to, for example, accesses made by the terminal or to a list of the user, a service provider, a telecommunications operator, a network access provider or the operator of the routing server.

In this example, the dictionary 20ₐ comprises codes related to an access in progress, the dictionary 20_{b} comprises codes appropriate for the operator A, the dictionary 20_{c} comprises codes related to the accesses made by the terminal and the dictionary 20_{d} comprises codes related to the favorites of the terminal.

These dictionaries are updated based on their nature. For example, the dictionary related to the accesses made by the terminal 10a is changed so as to include the last codes selected by the user and having resulted in an access to a server or data.

These dictionaries are thus used to determine which codes must be displayed following an input executed by the user of the terminal 10a. To that end, when a sequence of elements, such as numbers, letters or symbols are input, the codes that may correspond to the input in progress are determined by comparing the sequence of elements that are input with the codes of one or more dictionaries.

The selection of the dictionaries used depends on the context of the input, and this context comprises parameters such as an access in progress, an address displayed by the terminal, a beacon identifying a dictionary, the geographic location of the terminal, the telephone operator or network access provider in question, the preferences of the user, the type of terminal, the language used, the history of the sites visited, and the sites indicated as favorites.

Thus, by limiting the number of dictionaries used to determine the codes similar to an input, the terminal identifies a limited number of codes for an input, such that the user is not confronted with an excessively high number of codes displayed.

For example, it can be considered that the terminal 10a is in communication with a server who is a provider of sports data, a dictionary appropriate for this server having been loaded in the terminal 10a, this dictionary comprising a “world” code associated, in the routing server 16, with the address of data related to a sports championship.

Moreover, it is possible that a code “world” is also defined in the dictionary of the telephone operator, this code being associated with data related to a subscription offer for a set price, making communications in a large number of countries possible.

However, considering the context, i.e., the communication in progress with the sports server, if the user inputs “world” on his terminal, the code “world” displayed will correspond to the code of the sports dictionary associated in the routing server with data pertaining to a world soccer championship.

Different examples of use of a method according to the present invention are described below based on FIGS. 4, 5 and 6.

FIG. 4 shows the successive screens of a mobile telephone terminal accessing a server of the WAP network according to a method according to the present invention.

According to a first step (screen 30) the user of the terminal selects the tools of the telephone enabling him to access the Internet network via the WAP network.

When the different connection tools are displayed, the user triggers (screen 32) a predictive input program by requesting the tool “Go to” which calls up dictionaries of the terminal (screen 34).

It is recalled that a prediction of the input code in progress is executed by searching in one or more dictionaries of the terminal for all the codes that can correspond to the input elements in progress, and this correspondence takes into account the compact nature of the keypad of the terminal.

In this example, the user of the terminal, having pressed the keys 8 and 6, which may also correspond to the letters t/u/v and m/n/o, the prediction means select and display the codes “Flight”, “Trip” and “Tourism” (screen 34) corresponding to the input and to the codes most frequently selected by the user of the terminal.

In other words, thanks to the use of these dictionaries in the prediction of the input code in progress, it is possible to propose a short list of codes that may correspond to the input code in progress.

When the user of the terminal selects the code displayed “Flight,” this selected code is transmitted to the routing server (screen 36), which, identifying the address of the requested server or data, transmits this address to the terminal so that the latter is connected to this address (screen 38).

At the same time, an update of the dictionary appropriate for the history of the accesses of the terminal is executed.

It should be pointed out that the codes of the history dictionary are displayed by order of frequency in this example, while, in a variant, these codes are displayed alphabetically.

Two variants of a method for communication according to the present invention which are accessible by an Internet connection tool are shown in FIG. 5.

According to a first variant (screen 40a), the user of the terminal executes an input, such as described in FIG. 4, i.e., using keys common to different letters, a combination of which determines the code sought by the user.

In this example, the input “4653” leads to the determination of the combinations among a letter from each of the keys 12₄, 12₆, 12₅ and 12₃ (FIG. 1), the terminal transmitting the input to a routing server (screen 42a) so that the latter determines the codes that may correspond to this input.

In this example, two codes “Golf” and “Gold” are identified by the routing server and are transmitted to the terminal which displays (screen 44a) in such a way that, by selecting the code “Golf,” the terminal is put into communication, via the routing server (screen 46a), with the server whose address is associated with this code (screen 48) in the base of the routing server.

According to a second variant, the user of the terminal inputs the code corresponding to a server (screen 40b). Since such an input is executed by means of the navigator of the terminal, this input is transmitted to the routing server (screen 42b) and, if the input corresponds to a code associated with a single address, the routing server transmits this single address to the terminal so that the latter may access this address (screen 48).

So as to limit the storage capacity required by the method in the terminal, it is preferable to limit the number of codes registered in the terminal. In this case, the dictionaries of the terminal store a number of codes that is less than the number of codes stored in the routing server so that, when the user does not select a displayed code, the input executed is transmitted to the routing server so that the latter may identify a code corresponding to the input.

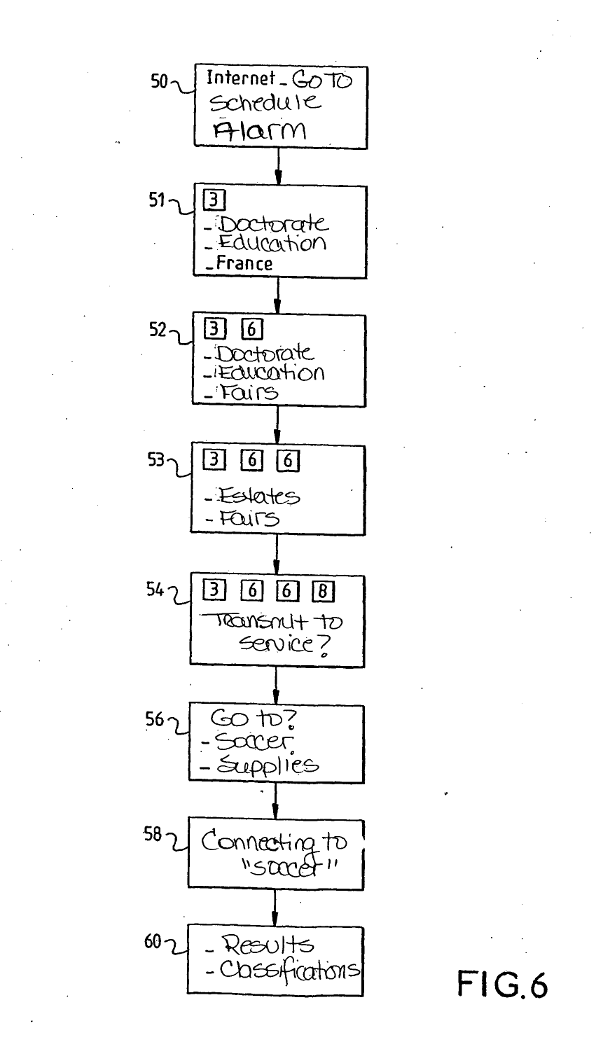

Such a situation is shown in FIG. 6. After having requested the use of a connection tool according to the present invention (screen 50), the user executes an input during which the codes stored in the terminal that may correspond to the input executed are displayed (screens 51 through 53).

However, at the end of the input (screen 53), no code displayed corresponds to a code desired by the user. Consequently, the connection tool suggests (screen 54) to the user to search among the codes stored in the routing server.

If this suggestion is accepted, the terminal transmits the input to the routing server (screen 55), analogously to a code, so that the latter identifies codes that may correspond to the input executed by the user of the terminal and may transmit the latter [codes] to the terminal for display (screen 56).

When the user of the terminal selects (screen 56) one of the codes transmitted by the server, the terminal accesses the server (screens 58 and 60) corresponding to the address associated with this code according to the present invention.

The present invention may have many variants. Thus, the routing server 16 may comprise means for executing statistics, for example, the frequency of accessing a server or data.

According to one variant, the data transmitted by the routing server to the terminal are compressed so as to limit the transmission times, the terminal comprising means for decompressing these data or for processing these data without decompressing them.

In another variant, a terminal according to the present invention comprises means for displaying the codes, selected on the basis of first parameters, according to an order appropriate for the dictionaries from which these codes are derived. For example, the codes derived from a dictionary appropriate for accessing a server or data are displayed before the codes derived from the dictionary of the operator, the codes derived from the history dictionary being displayed last.

In one embodiment, the terminal comprises means so that its user limits the access to codes by means of a password, for example, in order to execute parental control.

1. Method for communication between a terminal and a server of a communication network, the server or data of the server being identified by an address, the method comprising:
when a user of the terminal executes an input, displaying codes stored in a code base of the terminal and selected based on first parameters so that the user selects a code,
transmitting the selected code to a routing server which identifies, based on second parameters, an address associated with the code selected and stored in a base of the routing server, and
transmitting the identified address to the terminal which automatically accesses the identified address.

2. A method in accordance with claim 1, comprising the step of changing the code base of the terminal or changing an address of the routing server stored by the terminal for transmitting a code to the routing server by transmitting a command from the routing server.

3. A method in accordance with claim 2, comprising changing the code base of the terminal by executing at least one of the following operations: the storage of a new code, the elimination of a code, the creation, changing or deletion of a code group or dictionary, the allocation of a display priority among the codes.

4. A method in accordance with claim 2 or 3, comprising transmitting a change command when the server communicates an address to the terminal.

5. A method in accordance with claims 1, 2 or 3, comprising considering a similarity between the input and a stored code to be one of the first parameters, such that the codes that are displayed are the codes most similar to the input.

6. A method in accordance with claim 5, comprising allocating a of cost for each correction of an element of the input, to obtain an element of the code to determine similarity between the input and a code, wherein a lower sum of the costs for obtaining a code by correcting an input, corresponds to a higher similarity between the input and one of the codes.

7. A method in accordance with claims 1, 2 or 3, comprising selecting codes and displaying the selected codes as the input, considering the first elements input with the first elements of codes of the base.

8. A method in accordance with claims 1, 2 or 3, comprising considering the input to be a code that is transmitted to the routing server.

9. A method in accordance with claims 1, 2 or 3, comprising grouping the codes of the terminal into dictionaries, each dictionary being characteristic of a category of codes.

10. A method in accordance with claim 9, comprising considering a context of the input to be a first selection parameter, setting a selection priority among the codes coming from different dictionaries, the context being related to at least one parameters selected from a group consisting of: data displayed by the terminal, an access in progress, a communication in progress, a geographic location of the terminal, a telephone operator transmitting the communications, a network access provider, a history of the accesses made, sites indicated as favorites, the type of the terminal, or an operating language of the terminal.

11. A method in accordance with claim 10, comprising transmitting the at least one parameter of the context of the input to the routing server during the transmission of a code.

12. A method in accordance with claim 11, wherein addresses or codes associated with addresses are grouped by dictionaries characteristic of an address category, a parameter of the context of the input or an identifier of the user is used as one of the second selection parameters allocating a priority to an address coming from a first dictionary vis-à-vis an address coming from a second dictionary or to a code coming from the first dictionary vis-à-vis a code coming from the second dictionary.

13. A method in accordance with claims 1, 2 or 3, wherein an intermediate server comprising an address base provided by the base of the routing server is used to receive the code sent by the terminal for transmitting an address or codes to the terminal, for transmitting the code received to the routing server or for transmitting commands changing the code base of the terminal.

14. A communication terminal accessing servers or data of the servers via a communication network by means of an address according to a communication protocol, comprising:
means for displaying the codes stored in a base of the terminal and selected on the based on first parameters when a user of the terminal executes an input so that the user selects a code,
means for transmitting the selected code to a routing server and for receiving an address from the routing server for automatically accessing the address or codes for displaying the address.

15. A terminal in accordance with claim 14, comprising means for receiving from the routing server a command changing the code base of the terminal or changing an address of the routing server.

16. A terminal in accordance with claim 15, comprising means for changing the code base of the terminal by executing an operation selected from a group consisting of: the storage of a new code, elimination of a code, creation, changing or deletion of a code group or dictionary, or allocation of a display priority among the codes.

17. A terminal in accordance with one of the claims 14 through 16, comprising means for considering a similarity between the input and a stored code to be a first parameter for selecting displayed codes.

18. A terminal in accordance with claim 17, comprising means for determining the similarity between the input and a code by allocating a cost for each correction of an element of the input, to obtain an element of the code, wherein a lower sum of the costs for obtaining a code by correcting an input, corresponds to a higher similarity between the input and one of the codes.

19. A terminal in accordance with claims 14 through 16, comprising means for dividing the code base into sub-bases, or dictionaries characteristic of a code category.

20. A terminal in accordance with claim 19, comprising means for considering a context of the input to be one of the first selection parameters, setting a selection priority among the codes of different dictionaries, the context being selected from a group consisting of: data displayed by the terminal, an access in progress, a communication in progress, a geographic location of the terminal, a telephone operator transmitting communications, a network access provider, a history of the sites visited, sites indicated as favorites, a manufacturer of the terminal, or an input language.

21. A terminal in accordance with claim 20, comprising means for selecting and displaying the codes as the input based on a similarity between the first elements of the input and the first elements of the codes of the base.

22. A communication network server wherein a server or data of the server are accessible by means of an address according to a communication protocol, comprising:
means for receiving a code transmitted by a terminal, for identifying, in a base, an address or codes associated with the code received based on second parameters and for transmitting the address or the code to the terminal, and
means for commanding a change in a code base in the terminal transmitting the code.

23. A server in accordance with claim 22, comprising means for considering a similarity between the code transmitted by the terminal and codes associated with addresses in the base of the terminal to be one of the second selection parameters.

24. A server in accordance with claim 23, comprising means for dividing the code base into sub-bases, or dictionaries, comprising codes which are characteristic of a service provider, a telecommunications operator, a network access provider or an operator of the routing server.

25. A server in accordance with claim 24, comprising means for considering a context of the transmission of the code by the terminal to be one of the second selection parameters, setting a selection priority among different code or address groups or dictionaries, the context being related to a parameter selected from a group consisting of: an input field placed in the access means of the terminal, data displayed by the terminal, an access in progress, a communication in progress, a geographic location of the terminal, a telephone operator transmitting communications, a network access provider, a history of the sites visited, sites indicated as favorites, a manufacturer of the terminal, or an input language.

26. A server in accordance with one of the claims 22 through 25, comprising means so that, when the server transmits a server or data address to the terminal, it commands the terminal to store codes, or a dictionary, on the basis of the address of the server or data transmitted.
